(19) United States
(12) Patent Application Publication
(10) Pub. No.: US 2004/0050674 A1
(43) Pub. Date: Mar. 18, 2004

(54) Mechanically bi-stable mems relay device

(76) Inventor: Paul John Rubel, Santa Barbara, CA (US)

Correspondence Address: Paul J. Rubel, Innovative Micro Technology, 75 Robin Hill Road, Goleta, CA, 93117, US

(21) Appl. No.: 10/243,705

(22) Filed: Sep. 14, 2002

(51) Int. Cl. H01H 51/22; H01H 57/00

(52) U.S. Cl. 200/181

(57) ABSTRACT

A micromechanical switch formed on the top of a fabrication substrate, by deposition of a stressed material which flexes either toward or away from the substrate surface in order to relieve the stress in the material. The switch operates by magnetostatic interaction with an adjacent magnetic core, which draws a portion of the switch toward core. The switch is equipped with conducting bridges which connect a set of input leads with a set of output leads, depending on the orientation of the switch. The switch is sealed during fabrication by an adjacent capping wafer, with electrical access to the switch provided by vias etched through the thickness of the fabrication substrate. Connection to the sealed unit can therefore be made by ball bonding, or other suitable contact methods, to the underside of the fabrication substrate.

### FIELD OF THE INVENTION

This invention relates to the design and packaging of microelectromechanical switches.

### BACKGROUND OF THE INVENTION

High speed, radio frequency (RF) switching devices are becoming a requirement for a wide variety of applications. In telecommunications for example, RF relays are used to select transmission versus reception mode for cellular telephones and other broadcast devices. In these applications, the relays need to have low insertion loss, low DC power loss, accommodate large wattages, and have large signal rejection or low crosstalk. High-speed switching devices are required to reduce delay times in switching between transmit and receive modes.

In phased array antennas, a combination of delay lines and relays allows directional scanning without physically rotating a dish. The variable delay shifts the phase between various elements in the array, which gives the array a tight directional solid angle for listening or broadcasting. Radar currently uses such phased array antennas to sweep the direction of the RF beam. RF relays are used for this application, which requires high speed, low cross talk, and low insertion loss.

Present technology competing with RF relays includes primarily PIN diodes and GaAs FET switches. Each of these technologies suffers from one of a number of disadvantages. FET switches have finite ON resistance and poor isolation. They also generate harmonics, requiring low pass filters. The PIN diode has a nonlinear operating current, and the ON current must exceed the RF current. Both devices suffer from loss and reflection due to wire bonding to the device, which breaks the continuity of the transmission line.

Such performance considerations favor the development of miniature mechanical (solenoidal) switches. Such mechanical devices have low insertion loss, and because they are three terminal devices, the control line is completely separate from the RF signal source. In the open position, they are essentially open circuits, such that the isolation may exceed 45 dB. In the closed position, they are closed circuits, with less than 1 mW of DC power consumed. This combination of features makes solenoidal switches attractive for RF applications.

For communications as well as other applications, cost, power, and speed requirements have motivated the development of microscopic solenoidal switches using photolithographic techniques. These devices are known as microelectromechanical systems, or MEMS. Because of their small size, MEMS switches generally have high speed, low inertia and low power requirements. Batch fabrication techniques may also make MEMS a low cost approach to switching arrays.

Micromechanical switches such as those proposed for telecommunications generally have a member or armature driven between a plurality of mechanically stable states. That is, the system has a number of positions in which the driven member can reside in equilibrium, in the absence of a driving force. Frequently, the system is bistable, i.e. there are two positions in which the driven member can reside in equilibrium. In the example of the optical switch, the two states might be with the optical element “extended”or “retracted”. In the case of an electrical switch the two states might be “off” or “on”. In the case of a valve, the two states might be “open” or “shut”. An energy barrier, generally created by springs, cams and/or mechanical detentes, separates the equilibrium positions. The purpose of the actuator is to shift the driven member over the energy barrier between these states, within a prescribed switching time.

Since the devices are bi-stable, they cannot rely on relaxation of a spring force to return them to their initial positions. Therefore, two separate actuation means must generally be provided, one which impels the driven member from its first equilibrium position to its second, extended equilibrium position, and another which retracts it to its original first equilibrium position. This requirement can complicate the switch design, as an actuator must be placed on either side of the driven member, each of which delivers a force in opposing directions.

Moreover, the use of moveable members in these systems also creates the possibility of debris or mechanical damage occurring during post-processing, such as during the dicing of the wafer. It is therefore desirable to encapsulate the active switch early in fabrication, to make a package more resilient to downstream handling. However encapsulation in a protective package makes electrical access to the device problematic. Therefore, a problem remains with micromechanical switches, in that sensitivity to post-processes requires careful handling to avoid damage and contamination of the devices.

Lastly, the need for bearings and springs in order to make moveable members, and to create the bi-stable conditions, complicates the design of the switches. This disclosure describes a relatively simple switch design, which accomplishes a bi-stable state with a single spring, which can be actuated into either of the bi-stable states by a pulling-type actuator operating on one side of the switch only. The design requires no free-turning bearings or additional detente springs.

### BRIEF SUMMARY OF THE INVENTION

A micromechanical switch is formed on the top of a fabrication substrate, by either the deposition of a stressed material forming a structure or the bonding of a preloaded structure to the substrate. This structure flexes either toward or away from the substrate surface in order to relieve a portion of the stress in the material. The switch operates by magnetostatic or electrostatic interaction with an adjacent magnetic core, which draws a portion of the switch towards the core. Because the actuation mechanism is magnetostatic, the switch is capable of relatively high contact pressures, which is important in getting intimate contact between the mating surfaces of the switch and low contact resistance. The switch is equipped with conducting bridges which connect a set of input leads with a set of output leads, depending on the orientation of the switch. After formation of the elements of the MEMS switch, the device is protected by sealing the moving components of the switch in a hermetic cap while still at the wafer level. Electrical access to the switch is afforded by vias formed though the thickness of the substrate which supports the switch.

### BRIEF DESCRIPTION OF THE DRAWINGS

The present invention will be understood more fully from the following detailed description, and from the accompanying drawings, which however, should not be taken to limit the invention to the specific embodiments shown but are for explanation and understanding only.

FIG. 1 is a perspective view of a bi-stable magnetostatic micromechanical switch, showing the torsional hinges.

FIG. 2a is a simplified schematic of the bi-stable magnetostatic micromechanical switch in the first equilibrium position. FIG. 2b is a simplified schematic of the bi-stable magnetostatic micromechanical switch in the second equilibrium position.

FIG. 3a is a simplified schematic of the bi-stable micromechanical switch; FIG. b is a simplified schematic of the bi-stable switch under actuation force; FIG. 3c is a simplified schematic of the bi-stable switch showing deformation of concave portion under actuation force; FIG. 3d is a simplified schematic of the bi-stable switch with the axial force vector in line with hinge pivot point; FIG. 3e is a simplified schematic of the bistable switch with the axial force vector pointed below the hinge pivot point; FIG. 3f is a simplified schematic of the bi-stable switch with the concave portion inverted.

FIG. 4 is a plan view of the top portion of the stressed beam on its fabrication substrate.

FIG. 5 is a simplified schematic of the motor level on the fabrication wafer of the magnetostatic micromechanical switch.

FIG. 6 is a perspective view of the bi-stable electrostatic switch with the electrostatic actuators visible.

FIG. 7 is a plan view of the magnetostatic switch showing the conducting bridges.

FIG. 8 a simplified view of the conducting bridge contacting the lower spherical contacts.

FIG. 9 is a perspective view of the full magnetostatic micromechanical switch.

FIG. 10 is an isometric view of the lid as it is mounted to the magnetostatic micromechanical switch.

### DETAILED DESCRIPTION

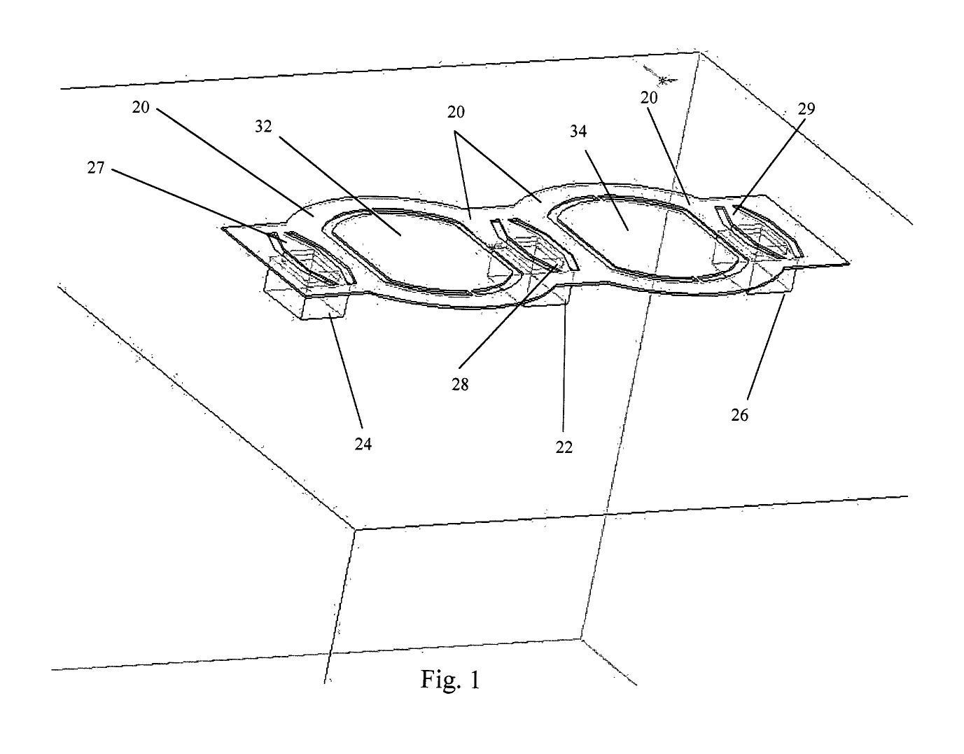

FIG. 1 shows a first embodiment of the bi-stable switch, which is a MEMS device built upon a silicon substrate. The switch comprises a driven member, 20, which is caused to move between two equilibrium orientations by magnetostatic interaction. For clarity, the switch alone is shown in the figure, without the magnetostatic actuators. The driven member is a stressed spring 20 made of compliant material, deposited or bonded on a minimum of three support pillars, 22, 24 and 26. These pillars both elevate the driven member and act as anchor points. Incorporated in the driven member, adjacent to the anchor points are torsional hinges, 27, 28 and 29, which allow the driven member to twist or rotate about the anchor point, but not to translate horizontally or vertically. These pillar/hinges are arranged in such a way that there is a center pillar/hinge 22 and two outboard pillar/hinges 24 and 26. The switch also comprises two magnetic plates 32 and 34, which will interact with two magnetostatic actuators located below the plates, but not shown in this figure.

The hinges are realized by the removal of portions of the body of the driven member, causing the driven member to become compliant about certain axes of rotation. For example FIG. 1 shows the removal of two curved features adjacent to the anchor point 26. These voids promote flexibility of the driven member about the axis longitudinal to the curved features, and create the hinge 29. Numerous variations in the shape of the features is possible; the curved features shown have the advantage of maximizing the rigidity in the horizontal and vertical planes of movement while reducing rigidity to torsional bending.

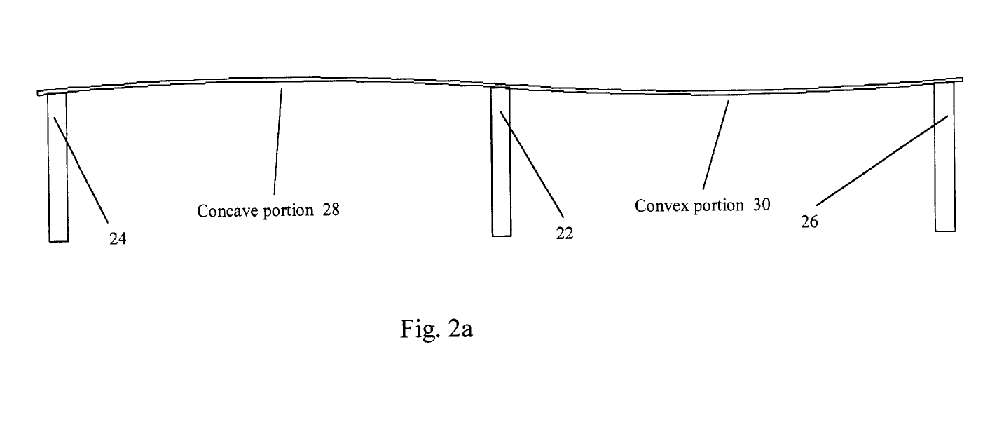

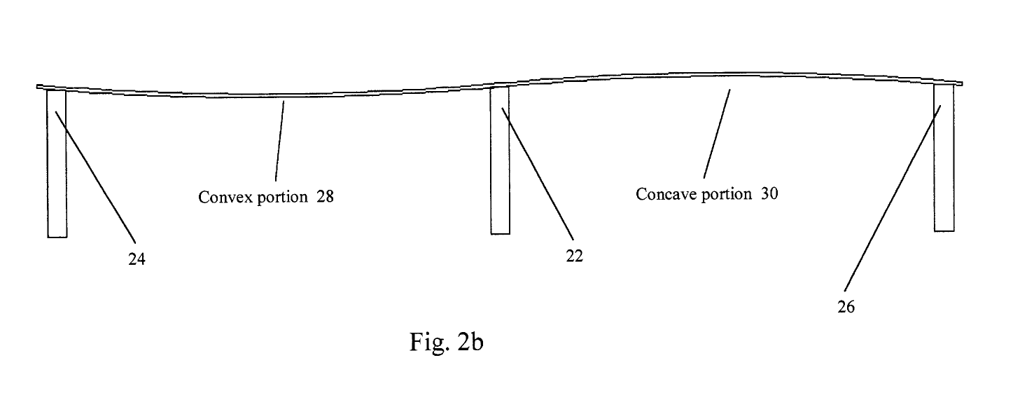

The driven member is manufactured in such a way as to impart compressive stress to the structure. The compressive stress in the structure will urge it to elongate. Since the hinges and anchors prevent any movement in the longitudinal direction, the driven member will bow in a concave or convex shape to relieve the stress. This shape gives the driven member additional arc length between the stationary anchor points, which satisfies the compressive stress in the driven member. Since the hinges are torsionally compliant, they will rotate as the driven member takes the bowed shape. In particular, the center hinge provides a node point through which the beam must pass. The center hinge transmits the slope of the incoming segment to the outgoing segment. Therefore when the beam is in the concave orientation between the leftmost and center hinge, portion 28, it will be convex between the center and the rightmost hinge/anchor, portion 30. This situation is shown in FIG. 2a.

Therefore, a first equilibrium position for the stressed driven member is for the segment between the leftmost anchor/hinge and the center anchor/hinge, to be concave with respect to the substrate surface (concave portion 28), and the segment between the center anchor/hinge and the rightmost anchor/hinge to be convex with respect to the substrate surface (convex portion 30). A second equilibrium position exists, in which the driven member curvature is inflected and opposite that of the first equilibrium position. That is, the stressed driven member in the segment between the leftmost anchor/hinge and the center anchor/hinge is convex, (convex portion 28), and between the center anchor/hinge and the rightmost anchor/hinge, the stressed driven member is concave with respect to the surface of the substrate, (concave portion 30). This situation is shown in FIG. 2b.

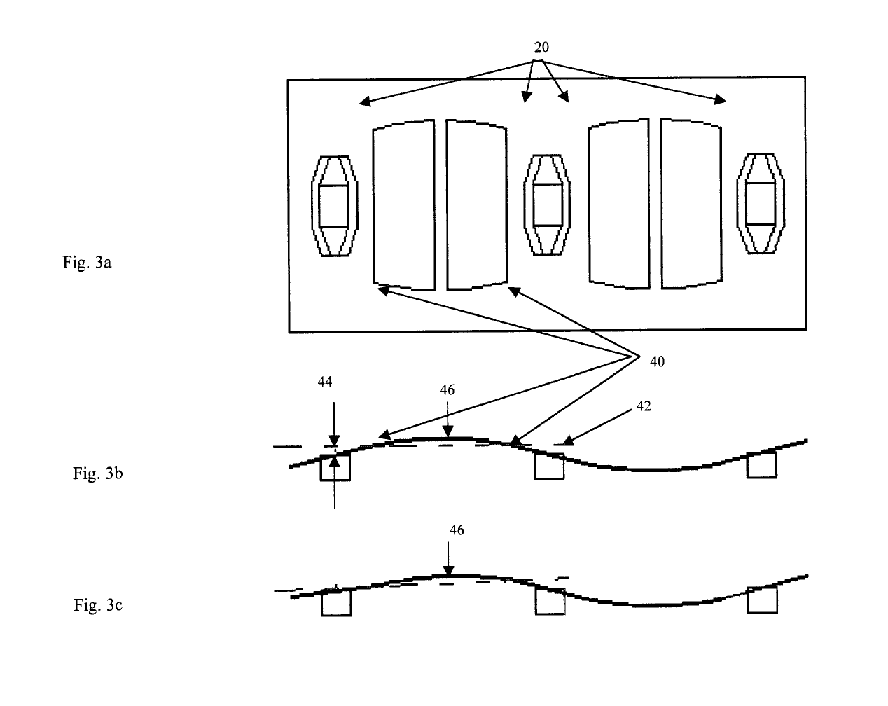

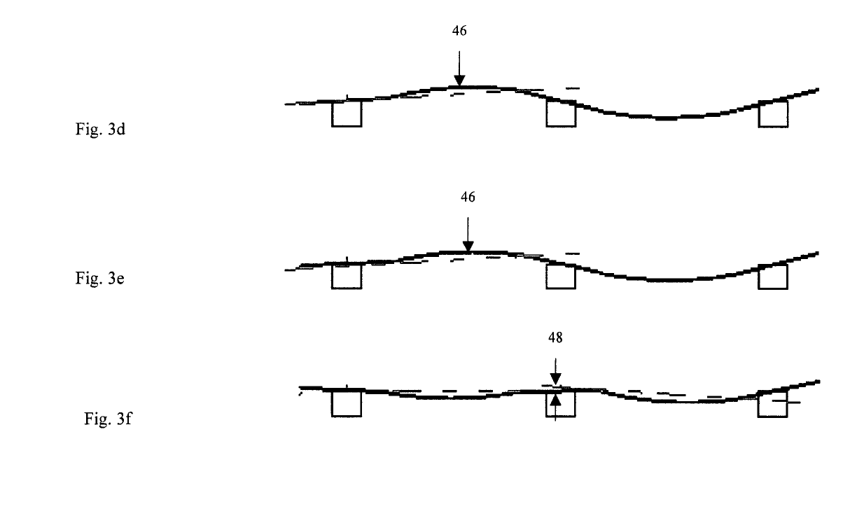

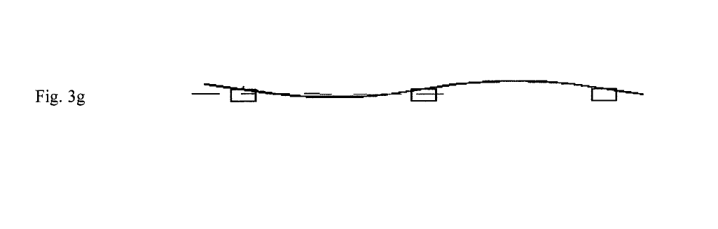

The switch is driven between the two equilibrium orientations by magnetostatic interaction with a magnetostatic actuator, which effects a pull down force on the magnetic plate 32 attached to the apex of the concave portion of the driven member. The pull down force 46 results in a deformation of the stressed driven member, flattening the concave portion, as shown in FIGS. 3b and 3c. The areas 20 surrounding the outside and center hinges are designed to be rigid relative to the beams of the device, and therefore most of the bending will take place at the juncture between the compliant beams and the rigid areas. The bending of these beams creates an axial reaction force that is applied to the rigid areas 20. The reaction force is applied in a direction substantially equal to the line drawn between the points of attachment 40 of the beams to the rigid areas. FIG. 3b illustrates this vector, designated as 42. The axial force vector imparts a torque on the hinge via the lever arm 44, which is the distance between the axis of the hinge and the axial force vector. The pull down force 46 tends to flatten the apex region of the driven member, which rotates the hinges in a direction towards horizontal. The center hinge is stiffer than the outer hinge, because of the fact that both the concave and convex portions are attached to it. Because of the difference in stiffness between the center and the outer hinge, the concave portion deflects downward more severely at the outside rigid area than at the center. The situation is shown in FIG. 3c. The magnitude of this deflection reaches a stage at which the reaction force vector is pointed at the centerline of the torsional hinge, as in FIG. 3d. The lever arm upon which the torque can act is zero, so that this point constitutes an unstable local energy maximum.

At this point, any increase in deflection will cause the reaction force to point below the axis of rotation of the outside hinge. This produces a negative lever arm, which reverses the sign of the torque on the hinge, as depicted in FIG. 3e. This is the transition point, at which the hinge begins to rotate spontaneously to the opposite orientation, accelerating into the energy minimum. The negative torque causes further rotation of the outer hinge axis, which increases the lever arm upon which the axial reaction force can act, which further increases the rotation of the outer hinge axis, and the driven member transitions to the inverted state. Once the transition point is reached, the compressive stress of the beam assists the spontaneous inversion of the beam shape, as the beam seeks to expand to relieve the compressive stress. The driven member portion becomes inverted, assuming a convex shape from the original concave shape.

As the shape of the leftmost portion of the driven member is transitioning to the inverted state, it imparts a reverse moment on the center hinge, which transmits the moment to the convex rightmost portion of the hinge, now tending to flatten the rightmost portion. This situation is shown in FIG. 3f. The same mechanism then occurs in the rightmost portion, where the bending is accommodated first by the most stressed area of the driven member, which is at the juncture of the bending beam and the center hinge, 20. The center hinge rotates until the axial reaction force vector of the rightmost portion of the driven member 48 points above the axis of the center hinge, as shown in FIG. 3f. At this point the force vector acts to further increase the rotation of the center hinge axis, which increases the lever arm upon which the vector can act, which increases the rotation of the axis, and the system accelerates into the energy minimum, shown in FIG. 3g. The minimum energy situation is with the originally convex rightmost portion of the driven member in a concave orientation, so that the entire structure is inverted relative to its state before actuation. This is the second equilibrium position. The driven member can be switched back to the first equilibrium position by energizing once again the right magnetostatic actuator, which generates a pull down force on the apex of the concave portion of the driven member, which is now the rightmost portion.

The ability of one portion of the stressed driven member to invert the adjacent portion across the rigid center hinge is an important feature of the design, because it allows the driven member to have two stable states, which can both be reached with a pulling actuator. It is sufficient to have two pulling actuators, one under each portion of the driven member, which will interact with the concave portion of the driven member, whether it is the leftmost or the rightmost portion. With the actuator pulling the concave portion through to the convex orientation, this action alone is sufficient to force the adjacent convex portion into a concave shape by the torque transmitted through the center hinge. Without such a feature, the actuation means would have to be fabricated on the top and the bottom of the switch, in order to pull the switch back to the initial concave orientation. The requirement for an actuator on both the top and bottom of the switch would complicate the design and fabrication of the switch.

Another important attribute of the driven member as designed, is that the switching motion is rapidly damped. As shown in FIG. 2a, as the bi-stable switch comes near its equilibrium position, the motion approximates a plate wave vibration in which one wavelength equals the length of the plate. Plate modes are well known to be highly nonlinear, with the result that energy from the first, fundamental mode (n=1) will be converted into other modes, n=2, n=3, etc. For each of these modes, the frequency =n*f₁ , where f₁ is the frequency of the n=1 mode. For the case of a silicon plate, 2 um thick, 500 um long, f₁=100 kHz, f₂=200 kHz, etc. Damping of the fundamental mode proceeds rapidly as energy is converted into the other modes, each of which is damped as the energy in the mode turns into heat through frictional effects. Finally the system will come to equilibrium as all the energy from the original plate motion is converted into heat, with a resulting increase in plate temperature.

Mode-conversion and the resulting damping of plate waves is well-known, with one common example being the response of a musical cymbal. Initial excitation of the lowest order vibrational mode is quickly converted to higher-frequency modes, all of which attenuate in time. While cymbals are designed to resonate at some of the higher frequencies, if one avoids resonant conditions, rapid damping occurs. (See for example, “The Physics of Musical Instruments” by Neville H. Fletcher and Thomas D. Rossing, Springer-Verlag, NY 1998, pp. 649-669), incorporated herein by reference. Therefore the residual energy goes into low amplitude, high frequency, rapidly damped motion, and little perceptible motion continues after the switch is actuated. This feature is important in minimizing switching and settling time.

For creating the required stress in the stressed beam, several options exist. The first is to fabricate the beam itself under conditions in which the deposited material is inherently stressed. One material which is convenient for forming the stressed film is SiO₂ which can be deposited with a compressive stress of 3×10⁹ dynes. It is well known that bombardment of grown SiO₂ films by ions accelerated in the plasma by only a few tens of volts, penetrate only a few tens of angstroms but create defects, displacing the Si and O from the sites in the crystal lattice that they would otherwise occupy. Because of these induced defects, the volume occupied by the film is larger than that which a perfect film would occupy, causing compressive stress in the film. The defects can be induced by raising the gas pressure in the deposition chamber, and by applying a magnetic field to the substrate, which tends to ionize the ambient gas at greater frequency. A second option to achieve the required stressed condition is the deposition of a stressed film on either the top or bottom of the beam.

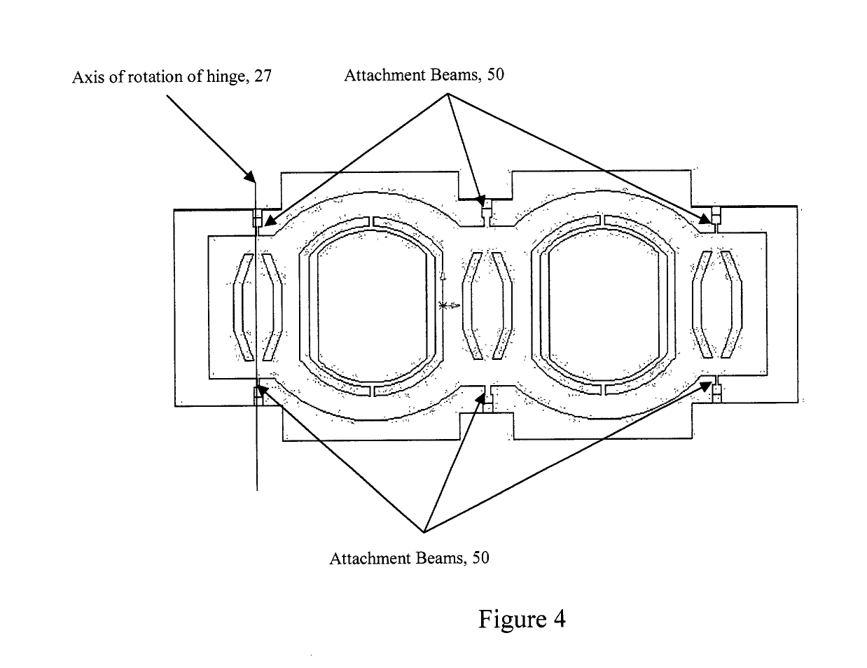

A third option to create the stressed condition is by depositing or bulk etching the driven member without the imparted stress and then to displace the outboard hinges inward from the as deposited state. This can be done by fabricating the driven member on one substrate, the hinge anchors on another substrate, then bonding the two substrates together at the anchor points. The displacement is created during the process of bringing the two wafers together. The driven member is fabricated on a first substrate such that it is attached to the substrate by at least six attachment beams at each hinge point. The situation is shown in FIG. 4, which is a plan view of the driven member attached to its fabrication substrate by a plurality of attachment hinges, 50. The attachment beams for the center hinge are rigid and do not allow translational movement in any direction, but allow rotational movement along its axis. The attachment beams for the outboard hinges are flexible in the longitudinal direction and rigid in all other directions. The substrate with the anchors has a sacrificial pillar on the wafer that lines up with a point on the driven member half way between the center and outboard hinges/anchors. As the two substrates are brought together, the first contact is made by the pillar. This pillar pushes the driven member upwards and pulls the outboard hinges inward. This deformation continues until the stressed member and the anchors come into contact and are bonded.

This assembly technique will result in both segments of the stressed driven member being in the concave state with respect to the substrate surface, as manufactured. The driven member can then be set in its first equilibrium position by magnetostatic actuation of the switch.

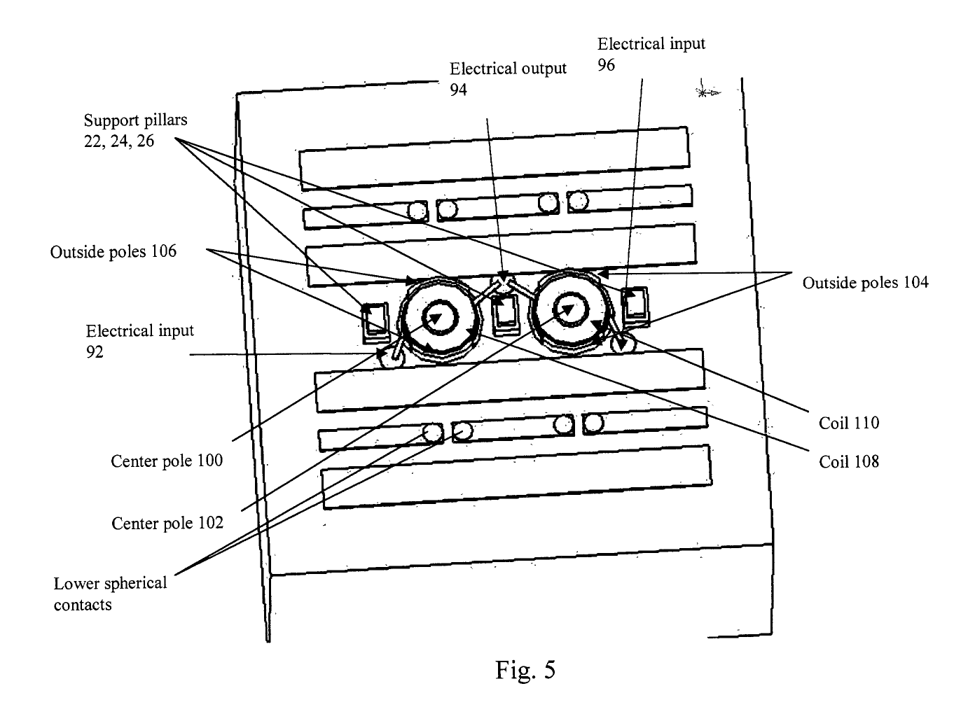

The magnetostatic actuation of the driven member between its two equilibrium positions is accomplished by magnetostatic interaction between plates of magnetic material 32 and 34 affixed to the driven member as shown on FIG. 1, and adjacent magnetic cores which are shown in detail in FIG. 5. FIG. 5 is a simplified diagram of the magnetostatic actuator level of the wafer, showing the magnetic structures and coils only; for clarity the overlaying stressed driven member has been omitted in this figure. The actuators comprise two sets of concentric cylindrical permeable magnetic features located between the anchor points 22, 24 and 26. The magnetic features include a pair of center poles 100 and 102 and two pairs of outside poles 104 and 106. Wound about each of the center poles is an electrical coil 108 and 110. Driving a current through either of these coils using input/output electrodes 92 and 94, or 94 and 96, generates a magnetic field passing through the coil, which induces a field in the permeable center pole encircled by the coil. To complete the magnetic circuit, the flux must return via the outside poles. The outside poles are linked magnetically to the center pole via a magnetic pedestal upon which the pole structures are built. When viewed from the side, this combination has the shape of an “E”, so that the structure is commonly termed an “E” block.

The magnetic core is separated from the two plates of magnetic material affixed to the stressed driven member by a gap. The gap accommodates flexing of the stressed driven member toward or away from the core. The magnetic field created by the current in the coil induces a parallel magnetization in the permeable center pole, and this magnetization circulates from the pole to the plate, across the gap. The magnetic circuit is completed by the plates of magnetic material, which deliver the magnetic flux back across the gap to the outside poles. The gap then acts as a pair of magnetic north/south pole faces, across which a magnetic field exists and interacts with the magnetic plate affixed to the stressed driven member. This interaction results in a force acting on the driven member. In the case of the plate of magnetic material being magnetically permeable, the force that results always urges the driven member to reduce the gap, that is, to be drawn toward the energized core. For this reason the actuator is called a “pulling” actuator. In this embodiment the magnetic material of the plates 32 and 34 is permeable, for example NiFe permalloy in a concentration of 80% Ni 20% Fe. However it may alternatively be made of permanent magnetic material such as CoSm.

The coil may be driven by connecting a voltage source or a current source across the input terminals to the coils 92 and 94, or 94 and 96. This core/gap arrangement is found in many applications and is known generally as a magnetostatic actuator. The formation of such magnetic features, as well as the energizing coils, is known in the MEMS art from the fabrication of, for example, micro electromechanical motors.

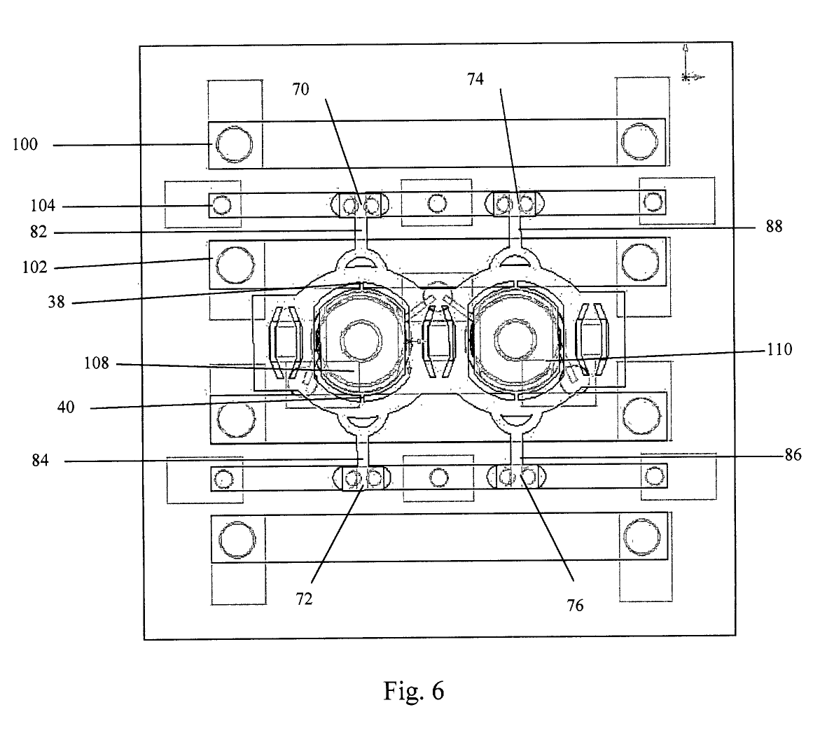

The magnetic plates are affixed to the compliant driven member at two attachment points 38 and 40 as shown in FIG. 6, to minimize stressing of the plate material by allowing the magnetic plates to remain horizontal as the compliant beam flexes. The attachment points are located near the apex regions of the flexed compliant driven member, so that the downward force is concentrated at the apex.

The driven member can be driven between the two equilibrium states by energizing successively each of the magnetostatic coils, which produce a magnetic field interacting with the plates of magnetic material affixed to the lower side of the driven member. Actuation results from energizing whichever core is adjacent to the concave portion of the driven member. Beginning with the driven member in a first equilibrium position, that is, with the left portion of the driven member in the concave orientation, and the right portion in the convex orientation, as shown in FIG. 2a, energizing first coil 108 draws the left outboard portion of the driven member toward the magnetic coil. The driven member bends and compresses in response to the magnetic force, reducing its concave shape by bending at the juncture between the compliant beams and the rigid areas, as has been previously described. As the magnetic force pulls the driven member beyond this point, the compressive stress in the driven member causes it to expand, and bow into a convex shape thus relieving the stress. The combination of this expansion of the driven member and the magnetic force pulls this area of the driven member to its lowest vertical point. The rigid center hinge rotates with the deflection of this area of the driven member. This rotation inputs a moment on the opposite driven member area forcing it upwards past its flat horizontal shape. At this point the compressive stress in the right outboard portion of the driven member causes the driven member to bow in a concave shape thus relieving the stress. The driven member then achieves its second equilibrium position, in the opposite, inflected state as was shown in FIG. 2b. A successive energizing of the other magnetic coil draws the right outboard portion back towards the core, causing the driven member to move back to the first equilibrium position.

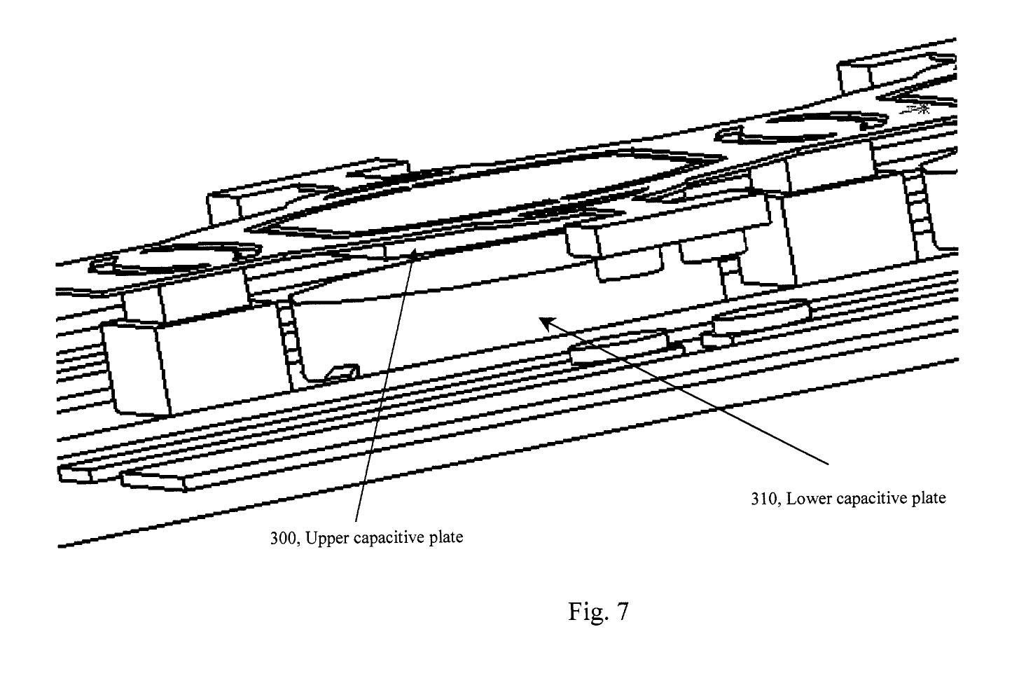

Electrostatic actuation can also be used to drive the stressed beam from one equilibrium state to another. An electrostatic switch is shown in FIG. 7. An electric force is generated between two conductive plates that have opposite charges, acting to pull the two plates together. In the case of the electrostatic actuator, one of these plates, the upper conductive plate 300, would be attached to the stressed beam in the same fashion the top pole of the magnetic motor was attached. The second plate 310 would be placed directly below the first plate 300 a distance equal or larger than the designed movement of the stressed beam. The second plate 310 would be placed in a similar orientation as the magnetic cores described above. These two plates would be electrically connected to a voltage source.

The driven member can be driven between the two equilibrium states by putting a voltage potential on the lower plate 310 below the plate attached to the concave portion of the stressed beam 300. The upper plate 300 on the stressed beam would be grounded. This will produce an electrostatic attraction between the two plates. Beginning with the driven member in a first equilibrium position, that is, with the left portion of the driven member in the concave orientation, and the right portion in the convex orientation, as shown in FIG. 2a, placing a voltage potential on the capacitive motor plate 310 draws the left outboard portion of the driven member toward the this plate. The driven member bends and compresses in response to the electrostatic force, reducing its concave shape by bending at the juncture between the compliant beams and the rigid areas, as has been previously described. As the electrostatic force pulls the driven member beyond this point, the compressive stress in the driven member causes it to expand, and bow into a convex shape thus relieving the stress. The combination of this expansion of the driven member and the electrostatic force pulls this area of the driven member to its lowest vertical point. The rigid center hinge rotates with the deflection of this area of the driven member. This rotation inputs a moment on the opposite driven member segment forcing it upwards past its flat horizontal shape. At this point the compressive stress in the right outboard portion of the driven member causes the driven member to bow in a concave shape thus relieving the stress. The driven member then achieves its second equilibrium position, in the opposite, inflected state as was shown in FIG. 2b. A successive energizing of the other electrostatic motor plate 404 draws the right outboard portion back towards the core, causing the driven member to move back to the first equilibrium position.

Other known methods of generating forces could be used to move the stressed beam from one equilibrium position to the other. These methods would include piezo-electric or thermal actuation. 44 The electrical relay which constitutes the RF switch is formed by two sets of ancillary cantilevered beams 82, 84, 86 and 88, that are integrated into the stressed driven member. The design of these beams is shown in FIG. 6, and pertains either to the magnetostatic or electrostatic embodiment. At the end of each cantilevered beam is a conducting bridge 70, 72, 74 and 76 each of which spans two lower spherical contact points deposited on the substrate. In the first equilibrium state of the stressed beam the bridges 74 and 76 are in the downward position and are in contact with two sets of lower spherical contact points on the surface of the substrate. This closes the relay junction across the first set of line out terminals 74 and 76, and opens the second set, with conducting bridges 70 and 72 lifted off of the lower spherical contact points. Energizing the left coil 108 draws the leftmost portion of the driven member toward the energized coil, which bends the driven member through its inflection point to the second equilibrium position. This raises the first set of conducting bridges 74 and 76 from the lower contact points, opening the first junction electrically, while lowering the second set of conducting bridges 70 and 72 onto the second set of contact points, closing the second junction electrically. This situation was shown in FIG. 2b. The first junction can be closed again and the second junction re-opened electrically by actuating the right coil 110.

The contact force is created by placing the lower contact pads at a height above the height at which the bridge would be positioned when the driven member is in the convex or down position. The cantilevered beam deflects an amount equal to this height differential. The contact force is the spring constant times the height differential, and for the design shown here, is of the order of 100 micro-Newtons.

The geometry of these integrated cantilevered beams is shown in FIG. 7. The cantilevered beams protrude from the stressed driven member in the area between the hinge attachment points. The cantilevered beams attach to the driven member at two points on either side of the apex or midpoint of the driven member. This is done to distribute the reaction force caused by the contact pressure across the stressed driven member. The cantilever is made relatively narrow in specific areas 82, 84, 86 and 88, to accommodate some torsional bending to adapt to variability in the elevation of the lower electrical contact points. This insures intimate contact between the relay electrodes and the conducting bridge.

The use of the cantilevered beams allows the electrical leads to be placed a substantial distance away from the metallic or conductive structures, in order to reduce capacitive losses.

It is noteworthy that this type of mechanical relay has very low leakage current, as when the switch is in the open position, the relay junction is an open circuit. However it also raises the input impedance to essentially infinity, which may cause unwanted reflection of the input wave. A solution is to provide a terminating circuit on the second set of line out terminals, which is invoked when the switch is in its second equilibrium position.

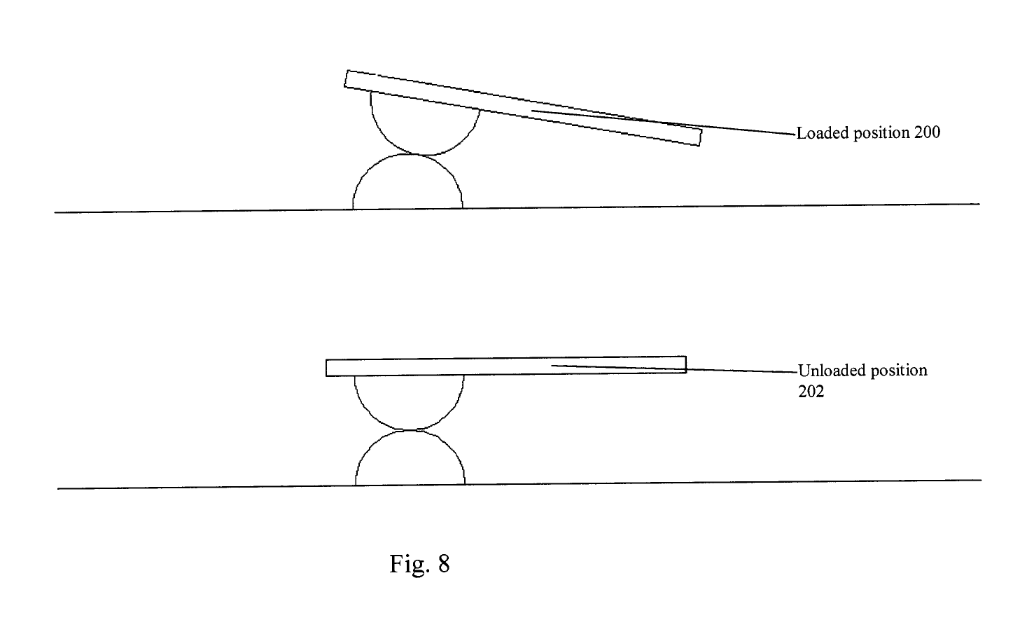

Stiction between the contacts is minimized by using spherically contoured contact points, on the conducting bridge and/or on the lower contacts. The curved contour gives the junction the advantage of rolling the contact surfaces to peel apart any adhered areas on the surfaces. The rolling action is illustrated in FIG. 8, which shows the cantilevered beams in the loaded position 200 and unloaded position 202. The cantilevered beams holding the contact bridges are designed such that the rotation of the spherical contacts on the bridge matches the radius of curvature of the lower spherical contact. This creates a peeling action as opposed to a scrubbing action. This peeling action can generate significantly higher tensile forces to separate the contacting surfaces as it rotates than the action of vertically separating the contacts. Tensile forces existing during peeling are more effective than scrubbing for breaking stiction or welded contacts. The exact geometry of the cantilever beam and the spherical contacts can be designed such that some combination of scrubbing and peeling occurs. The scrubbing action has the effect of cleaning off oxidation on the contact surfaces as contact is made. The peeling action breaks any adhesion between the two contacts during separation.

The peeling action creates a dynamic condition in which the spring is moving vertically but the two spherical contacts are still mated. At the point in the springs' vertical upward travel at which there is no more deformation of the cantilever spring and the peeling is complete, the velocity of the bridge is zero but the spring still has some velocity. This differential causes a high rate of acceleration separating the contacts. This acceleration prevents arcing and allows the relay to transmit larger currents. Lifetime estimates of the prior art technology yield a number of open/close cycles of 100 million, and is limited by contact stiction or welding. The peeling action eliminates this as a failure mechanism and allows a lifetime estimate in the range of 1 billion cycles.

Power transmission capabilities are increased and electrical noise characteristics are reduced by using the spherically contoured contact points on the conducting bridge and on the lower contacts. The curved contour gives the junction the advantage of point contact between the two surfaces, thus greatly increasing the contact pressure. This increased pressure creates a better mating between the two surfaces and allows for more efficient transfer of electrical power.

The device is manufactured according to the following steps, for the embodiment in which the stressed condition is created in the beam by deposition conditions: 1) deep reactive ion etching (DRIE) a trench the depth of the bottom portion of the “E” block 2) The bottom portion of the “E” block is plated in the trench up to and over the top of the substrate 3) The plated material is then planarized using chemical mechanical polishing to be coincident with the surface of the substrate. 4) An insulator layer is then deposited over the bottom of the “E” block only in the areas where the coils will be placed. 5) Coils are then plated on top of the insulator. 6) The transmission lines are plated at the same time as the coils. 7) The bottom contacts are then plated using standard plating techniques known in the industry 8) The spherical contacts are created by building a removable fence that surrounds the contact and then exposing the contacts to an ion beam at an angle offnormal and rotating the substrate. This fence will create preferential etching of the contact surface and create the spherical shape 9) The legs of the “E” blocks are then plated using standard plating techniques. 10) The stressed beam anchors are then plated using standard plating techniques. 11) A sacrificial layer made of a polymer is sprayed over the entire structure. This polymer is then planarized using industry standard techniques. 12) A second sacrificial polymer layer is spun or sprayed on top of the first sacrificial polymer layer to allow for the height differences between the stressed beam and the contacts and magnetic plates. 13) Standard industry photolithography techniques are used to pattern a trench for the magnetic plates and the top contac tbridge structure in the second sacrificial layer. 14) The spherical top contacts are created by ion milling the bottom of the photoresist cavity in the sacrificial layer. The ion beam is set at an angle off-normal and rotated. The outsides of the bottom of the contact cavity are thus shadowed by the sides of the cavity. The middle of the cavity is therefore etched more than the outside is etched, thus creating a spherical contour. 15) The contacts are then plated using industry standard techniques. 16) The magnetic plates are then plated and planarized using industry standard techniques. 17) The stressed film is then deposited using physical vapor deposition (PVD). The deposited material is SiO₂ and the typical deposition parameters are 10⁻⁸ torr base pressure, 3-10 mtorr Ar pressure, 30-100V substrate bias field, and a 50 Oe magnetic field on the substrate. 8) The film is patterned and etched using industry standard techniques. 19) The sacrificial layer is dissolved chemically thus releasing the stressed driven member. The device is then complete.

Vias are formed which allow electrical access to the terminal leads of the MEMS switch. The vias are formed in the silicon fabrication substrate by deep reactive ion etching (DRIE) through the entire thickness of the 675 um wafer, and plating conductive material into the through holes. Material such as copper is plated to a height extending beyond the opposing surface of the wafer, and the excess is lapped or polished back to being flush with the surface. For the case in which the substrate is sufficiently insulating, a typical process would be 1) Deposit NiFe on the back side of the wafer as an etch stop 2) Pattern the through holes on the front side of the wafer 3) DRIE the through holes to the NiFe etch stop 4) Put the wafer in a plating bath that only exposes the front side of the wafer 5) Connect the NiFe etch stop as the anode of the plating bath 6) Plate copper up from the bottom of the through hole where the NiFe is exposed, to and over the top of the through hole 7) Planarize the front side 8) Strip the NiFe from the backside. Since the copper plates up from the bottom, voids generally do not occur.

If the substrate is not sufficiently insulating, it may be required to put an electrically isolating layer between the wafer and the hole. This can be accomplished with chemical vapor deposition (CVD), for example depositing silicon dioxide. Because the chemical vapor deposition process and the etch stop material, usually metal, are not compatible, the process must be modified. A typical process for this situation would be 1) DRIE the via in the silicon substrate 2) deposit the isolation layer using CVD processes 3) using directional deposition processes, deposit a plating base on the backside of the wafer and inside the backside rim of the via 4) Put the wafer in a plating bath that only exposes the front side of the wafer 5) Connect the plating base as the anode of the plating bath 6) Plate copper up from the bottom rim of the via inward to initially seal the hole and then plate upwards from this sealed region to and over the top of the through hole 7) Planarize the front side 8) Strip the plating base from the back side.

On the bottom side of the vias a standard bumping process can be used to create a ball grid array for surface or board mount applications to the RF input lines. Therefore the design has the advantage of bonding the transmission lines of the device directly to the RF input lines, avoiding the impedance mismatch associated with wire bonding, and therefore improving insertion loss. The vias can also be used for wire bonding pads for situations where surface mount technology cannot be used.

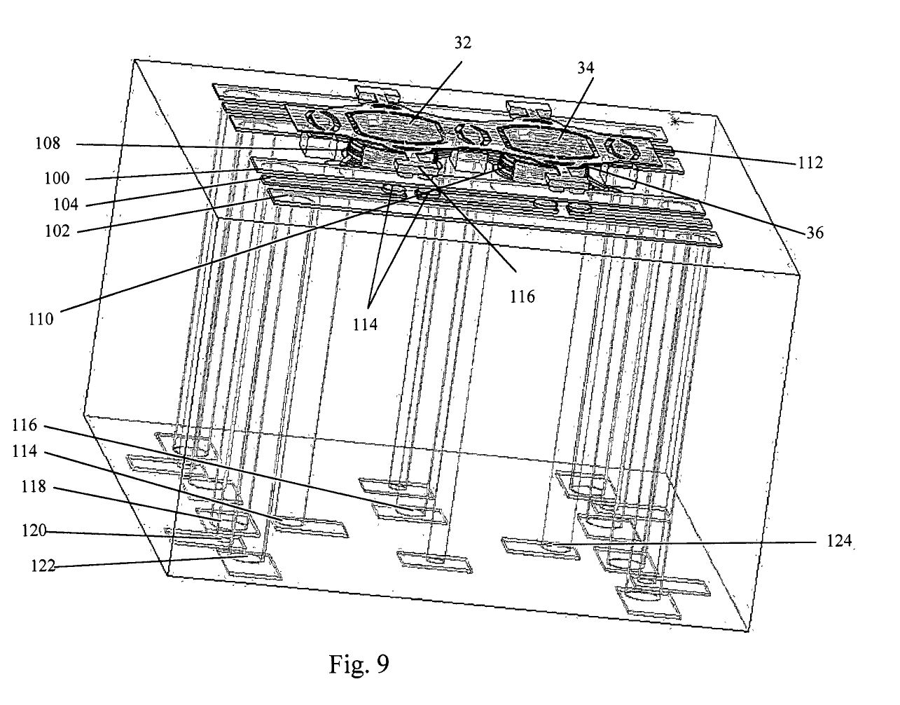

The complete bi-stable micromechanical switch structure is shown in FIG. 9. Vias and relay contacts are shown schematically in the figure, in the coplanar waveguide (CPW) embodiment. The ground planes are films 100 and 102, with the central conductor 104 completing the transmission line. The conducting bridge 116 attached to the stressed driven member 112 is shown, spanning the lower contact points 114 placed on the central conductor. The magnetostatic circuitry which drives the driven member is also shown, with magnetostatic actuators 108 and 110 connected to power sources through conducting vias 114,116 and 124. Note that the two coils share a common terminal 124. The ball bonding connection to the CPW input lines is shown in elements 118,120 and 122. Transmission line analysis shows that fabrication of a 50 um wide, 5 um thick central conductor, separated from the ground planes by 41 um, and deposited on a 675 um thick silicon substrate yields a 50 ohm transmission line with a propagation constant of 0.030 deg/um and loss of 0.053 dB/mm at 10 GHz.

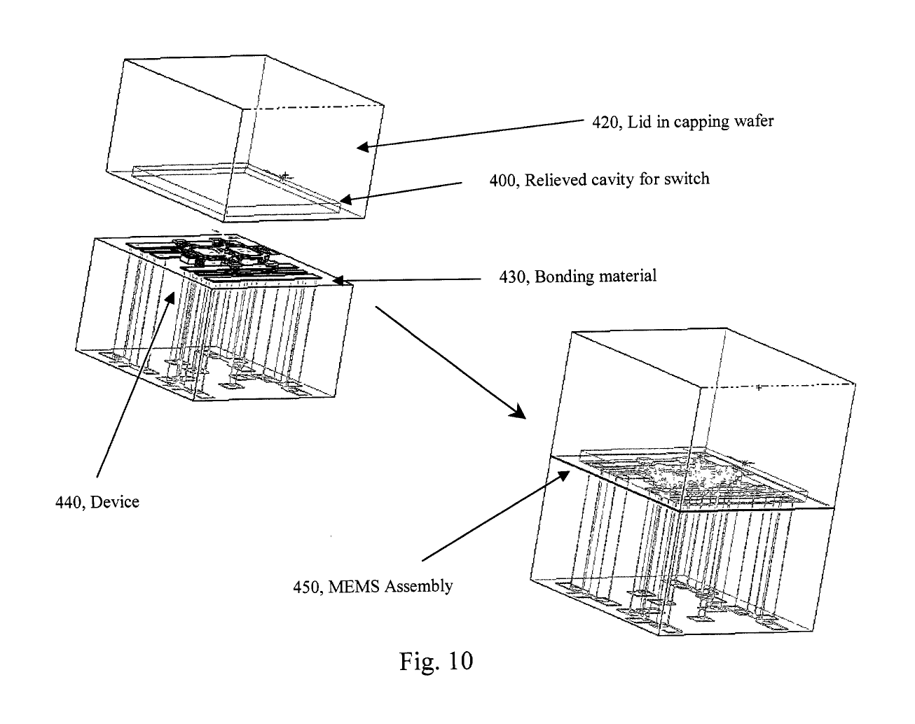

The encapsulating wafer is fabricated which will hermetically seal each of the individual MEMS devices. An exemplary isometric view of an encapsulating wafer is shown in FIG. 10. Voids or relieved areas 400 are formed in a silicon capping wafer, by deep reactive ion etching or a wet anisotropic etch. The voids are formed deep enough to allow clearance for the moving portions of the MEMS switch. One then patterns and plates eutectic bonding material 430 on the rims of the cavities, outlining the periphery of the MEMS device 440 and clearing all moving portions. Lastly, the capping wafer is aligned to the fabrication substrate, to register the cavities properly above the MEMS devices, and the capping wafer and fabrication substrate are bonded together to form a MEMS Assembly 450. Various adhesives may be used, including thermal bonding with a eutectic solder, or anodic bonding of pyrex glass to silicon, glass frit bonding, or epoxy bonding. The devices are thereby all packaged at once in the controlled environment of the clean room, and having been hermetically sealed, are ready for post-processing, such as dicing to separate the individual devices. The device is now ready to be shipped and connected directly to the RF input from the application. No further packaging is required.

While the invention has been particularly described and illustrated with reference to a preferred embodiment, it will be understood by those skilled in the art that changes in the description and illustrations may be made with respect to form and detail without departing from the spirit and scope of the invention. For example the magnetostatic forces may be manipulated by choice of film thicknesses and material composition. Spring constants may be varied by changing the aspect ratio of the beams or stiffnesses of the driven member material. Furthermore the switch design as described may be applied to other devices, such as a valve or shutter. Accordingly, the present invention is to be considered as encompassing all modifications and variations coming within the scope defined by the following claims.

I claim:

1. A bi-stable switch comprising:
a device substrate;
a hingedly mounted driven member attached to said substrate at three or more anchor points by torsional hinges;
an actuation means fabricated on said substrate and interacting with said hingedly mounted driven member to actuate said member from a first equilibrium position to a second equilibrium position; and
one or more conducting bridges attached to the driven member which open or close a set of contact relays attached to the conducting bridge and to the device substrate, depending on the orientation of the driven member in the first or the second equilibrium position.

2. A bi-stable micromechanical switch comprising:
a device substrate;
a hingedly mounted driven member attached to said substrate at three or more anchor points by torsional hinges;
an actuation means fabricated on said substrate and interacting with said hingedly mounted driven member to actuate said member from a first equilibrium position to a second equilibrium position; and
one or more conducting bridges attached to the driven member which open or close a set of contact relays attached to the conducting bridge and to the device substrate, depending on the orientation of the driven member in the first or the second equilibrium position.

3. The bi-stable micromechanical switch of claim 2, wherein a compressive spring force is imparted to the driven member by deposition conditions under which the member is fabricated.

4. The bi-stable micromechanical switch of claim 2, wherein a compressive spring force is imparted to the driven member by deposition of a stressed film on the driven member.

5. The bi-stable micromechanical switch of claim 2, wherein a compressive spring force is imparted to the driven member by physical displacement of two or more anchor points toward each other before bonding to another substrate.

6. The bi-stable micromechanical switch of claim 2, wherein the conducting bridges are attached to the driven member via integrated cantilevered beams.

7. The bi-stable micromechanical switch of claim 2, wherein the contact relays on both the conducting bridge and the device substrate have a spherical contour.

8. The bi-stable micromechanical switch of claim 6, wherein rotation of the spherical contact relays on the conducting bridge matches a radius of curvature of the spherical contact relays on the device substrate as the conducting bridge is loaded or unloaded from the contact relays.

9. The bi-stable micromechanical switch of claim 2, wherein the driven member assumes a concave shape with respect to the device substrate, between a first and a second anchor point, and assumes a convex shape with respect to the device substrate, between a second and third anchor point in the first equilibrium position.

10. The bi-stable micromechanical switch of claim 8, wherein a first actuation means causes the driven member to switch from a concave to a convex shape between a first and a second anchor point, and switch from a convex to a concave shape between a second and third anchor point in the second equilibrium position.

11. The bi-stable micromechanical switch of claim 9, wherein a second actuation means causes the driven member to return to a concave shape from a convex shape between a first and a second anchor point, and return to a convex shape from a concave shape between a second and a third anchor point in the first equilibrium position.

12. The bi-stable micromechanical switch of claim 9, wherein residual vibrations after actuation are highly damped by transmutation of the vibrations into other order plate modes.

13. The bi-stable micromechanical switch of claim 9, wherein said first equilibrium position applies the conductive bridge between an input lead and an output lead of said switch.

14. The bi-stable micromechanical switch of claim 9, wherein the second equilibrium position effects the removal of the conductive bridge between an input lead and an output lead of said switch.

15. The bi-stable micromechanical switch of claim 9, wherein each equilibrium position both applies a conducting bridge between one set of input and output leads and also removes a conductive bridge from a second set of input and output leads of said switch.

16. The bi-stable micromechanical switch of claim 13, wherein the second equilibrium position applies a terminating circuit to the output of the switch.

17. The bi-stable micromechanical switch of claim 2, wherein the actuation means interacts with said hingedly mounted member via magnetostatic forces.

18. The bi-stable micromechanical switch of claim 16, wherein the actuation means comprises a magnetic core which carries magnetic flux induced by a current-carrying coil wound about the magnetic core.

19. The bi-stable micromechanical switch of claim 17, wherein the current-carrying coil is partially or entirely encircled by a pair of outer magnetic poles which return the magnetic flux to the magnetic core.

20. The bi-stable micromechanical switch of claim 18, wherein the hingedly mounted member comprises a magnetic portion, which interacts with magnetic flux carried in the magnetic core and outer magnetic poles.

21. The bi-stable micromechanical switch of claim 19, wherein the magnetic portion comprises a plate of permeable magnetic material, affixed to the hingedly mounted driven member at a point near an apex of the driven member when it is in the concave or convex shape.

22. The bi-stable micromechanical switch of claim 20, wherein the permeable magnetic material is NiFe permalloy.

23. The bi-stable micromechanical switch of claim 2, wherein the actuation means interacts with said hingedly mounted member via electrostatic forces.

24. The bi-stable micromechanical switch of claim 22, wherein the actuation means comprises two charged capacitive plates which create an electric field between them and generate an attractive force.

25. The bi-stable micromechanical switch of claim 2, further comprising a capping wafer attached to said substrate, and so patterned as to provide clearance for said driven member to move from said first equilibrium position to said second equilibrium position, and attached to said device substrate such as to provide a protective seal of the driven member.

26. The bi-stable micromechanical switch of claim 24, wherein the capping wafer is attached by one of the following techniques: thermal bonding with eutectic solder, epoxy bonding, anodic bonding, gold silicon bonding, or glass frit bonding.

27. The bi-stable micromechanical switch of claim 24, wherein the capping wafer forms a hermetic seal with the device substrate.

28. The bi-stable micromechanical switch of claim 24, further comprising through hole vias rendered through the thickness of the device substrate, and deposited with conductive materials, in order to provide electrical access to the switch.

29. The bi-stable micromechanical switch of claim 27, wherein the conductive material is chosen from the group consisting of copper, gold, tungsten, tantalum and titanium.

30. The bi-stable micromechanical switch of claim 27, further comprising a layer of non-conductive material deposited into the vias, before depositing conductive material.

31. The bi-stable micromechanical switch of claim 27, further comprising ball bonding pads attached to the deposited conductive materials.

32. The bi-stable micromechanical switch of claim 27, further comprising ball grid array pads attached to the deposited conductive materials.
